(19) United States
(12) Patent Application Publication
(10) Pub. No.: US 2026/0118808 A1
(43) Pub. Date: Apr. 30, 2026

(54) IMAGE FORMING SYSTEM, NON-TRANSITORY COMPUTER READABLE MEDIUM AND IMAGE FORMING METHOD

(71) Applicant: FUJIFILM Business Innovation Corp., Tokyo (JP)

(72) Inventors: Hisao KOMAZAWA, Kanagawa (JP); Akiho YASUDA, Kanagawa (JP)

(73) Assignee: FUJIFILM Business Innovation Corp., Tokyo (JP)

(21) Appl. No.: 19/198,777

(22) Filed: May 5, 2025

(30) Foreign Application Priority Data
Oct. 28, 2024 (JP) 2024-189210

(51) Int. Cl. G03G 15/00; G06K 15/00

(52) U.S. Cl. CPC G03G 15/5062; G03G 15/6552; G06K 15/408; G06K 15/4095

(57) ABSTRACT

An image forming system includes a processor configured to: inspect a presence or absence of a fault on a printed material; and when disposal pages including a page determined to have a fault are to be discharged into a second discharge destination different from a first discharge destination into which a page determined to have no fault is to be discharged, switchably discharge into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.

### CROSS-REFERENCE TO RELATED APPLICATIONS

This application is based on and claims priority under 35 USC 119 from Japanese Patent Application No. 2024-189210 filed Oct. 28, 2024.

### BACKGROUND

### (i) Technical Field

The present disclosure relates to an image forming system, a non-transitory computer readable medium and an image forming method.

### (ii) Related Art

Japanese Unexamined Patent Application Publication No. 2021-165020 discloses a technique that may control whether a paper discharge destination is to be switched in response to inspection results of quality of a printed material.

Japanese Unexamined Patent Application Publication No. 2022-146528 discloses an inspection apparatus that, when a printed material having a portion thereof including multiple copies is inspected or when a printed material arranged in a sequential order is inspected, does not switch a paper discharge destination of the printed material even if inspection results indicate a fault.

Japanese Unexamined Patent Application Publication No. 2023-060721 discloses an inspection apparatus that, when inspection with raster image processor (RIP) image data serving as a reference image is performed, updates the reference image to be appropriate for the inspection if the reference image is inappropriate for the inspection.

Each page of a printed material is inspected for the presence or absence of a fault on the printed material produced by a printer, and a page determined to have a fault and a subsequent page in the middle of transportation are determined to be purge pages and discharged into a discharge destination, such as a top tray, different from a tray for normal pages. A printed material having a print content higher in confidentiality, such as a printed material including personal information, is typically discharged into a discharge destination, such as a stacker tray, from which the print content is difficult to visually recognize. However, if a purge page on a printed material higher in confidentiality is discharged into a discharge destination, such as a top tray, which is easy to visually recognize from the outside, the print content of the printed material may be possibly leaked.

### SUMMARY

Aspects of non-limiting embodiments of the present disclosure relate to providing an image forming system, a non-transitory computer readable medium and an image forming method that may block leaks of a print content of a disposal page on a printed material set to be higher in confidentiality.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including: a processor configured to: inspect a presence or absence of a fault on a printed material; and when disposal pages including a page determined to have a fault are to be discharged into a second discharge destination different from a first discharge destination into which a page determined to have no fault is to be discharged, switchably discharge into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.

### BRIEF DESCRIPTION OF THE DRAWINGS

Exemplary embodiment of the present disclosure will be described in detail based on the following figures, wherein:

FIG. 1 illustrates the system configuration of an image forming system in a first exemplary embodiment of the disclosure;

FIG. 2 illustrates reprinting that is performed by discharging, into a top tray, purge pages that include a page having a print fault detected in inspection;

FIGS. 3A through 3D illustrate a process of the image forming system when the purge pages are discharged into the top tray;

FIG. 4 illustrates the hardware configuration of the image forming system in the exemplary embodiment of the disclosure;

FIG. 5 is a block diagram illustrating the functional configuration of the image forming system in the exemplary embodiment of the disclosure;

FIG. 6 illustrates a setting screen example of a setting as to whether the function to discharge a disposal page into the top tray is enabled or disabled;

FIG. 7 illustrates an example of a determination method used when confidentiality is determined in accordance with a print content;

FIG. 8 is a flowchart illustrating a control process of switching the discharge destination of the image forming system in the exemplary embodiment of the disclosure; and

FIGS. 9A through 9D illustrate a process of the image forming system when the purge page is discharged as a disposal page into a stacker tray.

### DETAILED DESCRIPTION

Exemplary embodiment of the disclosure is described in detail with reference to the drawings.

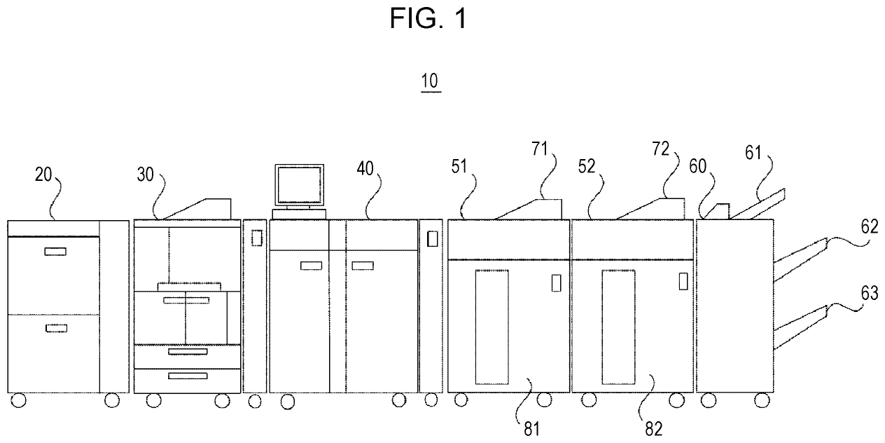

FIG. 1 illustrates the system configuration of an image forming system 10 in the embodiment of the disclosure.

Referring to FIG. 1, the image forming system 10 in the exemplary embodiment of the disclosure includes a paper feeder 20, printer 30, inspection apparatus 40, large-capacity stacker apparatuses 51 and 52 and post-processing apparatus 60.

The paper feeder 20 holding paper sheets supplies the printer 30 with the paper sheets. The printer 30 has the function of performing a printing operation to print an image on the paper sheet supplied by the paper feeder 20. The inspection apparatus 40 receives from the printer 30 the paper sheet with the image printed thereon and inspects the image printed on the paper sheet, namely, determines whether the image printed on the paper sheet has a fault, such as printing stains, bent corner or misregistration.

Specifically, the inspection apparatus 40 receives, as a reference image, image data of the image printed on the paper sheet from the printer 30, scans the image on the paper sheet transported from the printer 30, compares the received reference image with the scanned image, and thus inspects whether the image printed on the transported paper sheet has any fault.

The large-capacity stacker apparatus 51 includes a top tray 71 and stacker tray 81. The large-capacity stacker apparatus 52 includes a top tray 72 and stacker tray 82.

The stacker trays 81 and 82 are discharge destinations that are configured to protect a discharged paper sheet with a door and are capable of holding a large quantity of paper sheets having undergone the printing operation. The top trays 71 and 72 are respectively arranged on top of the large-capacity stacker apparatuses 51 and 52. The top trays 71 and 72 are discharge destinations into which the paper sheets having failed in the inspection of the inspection apparatus 40 are discharged.

The post-processing apparatus 60 performs, on the paper sheets inspected by the inspection apparatus 40, post-processing operations including a folding operation, stapling operation, punching operation and booklet production operation, and then discharges the paper sheets into a designated discharge tray. Note that the post-processing apparatus 60 includes the top tray 61 and finisher trays 62 and 63.

When a fault is detected on a paper sheet on the inspection apparatus 40, the image forming system 10 changes the discharge destination of the paper sheet to a discharge tray different from a standard discharge tray and then discharges the paper sheet into the selected discharge tray. When a fault is detected on the paper sheet serving as an inspection target in such an operation, performing simply reprinting may cause the page to be misaligned and multiple consecutive pages of a printed material may not be printed in correct order.

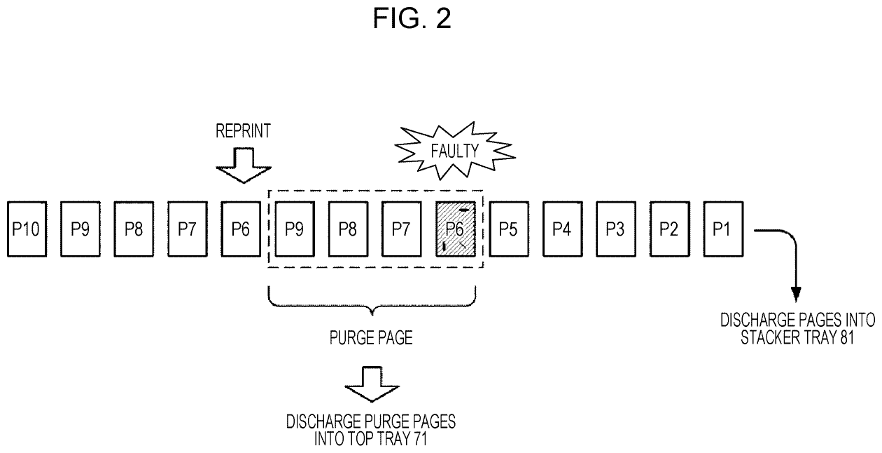

For example, referring to FIG. 2, page 6 may now be determined to have a print fault when 10 pages are printed on paper sheets having A4 sheet size. In the following discussion, a page determined to have a normal inspection result is discharged into the stacker tray 81 and a page determined to have a faulty inspection result is discharged into the top tray 71.

Since in such a case, pages 7 through 9 as the subsequent pages are already printed, simply reprinting only page 6 determined to have a faulty inspection result is not sufficient. When the inspection apparatus 40 determines that page 6 has a faulty inspection result, pages 7 through 9 are already printed and remain in the printer 30. In such a case, the discharge destination is switched to the top tray 71 as a discharge tray for disposal and four paper sheets of pages 6 through 9 are then discharged as purge pages into the top tray 71. Reprinting starts with page 6 causes a normal print result to be discharged into the stacker tray 81 in the order of from page 1 through page 10 without page misalignment.

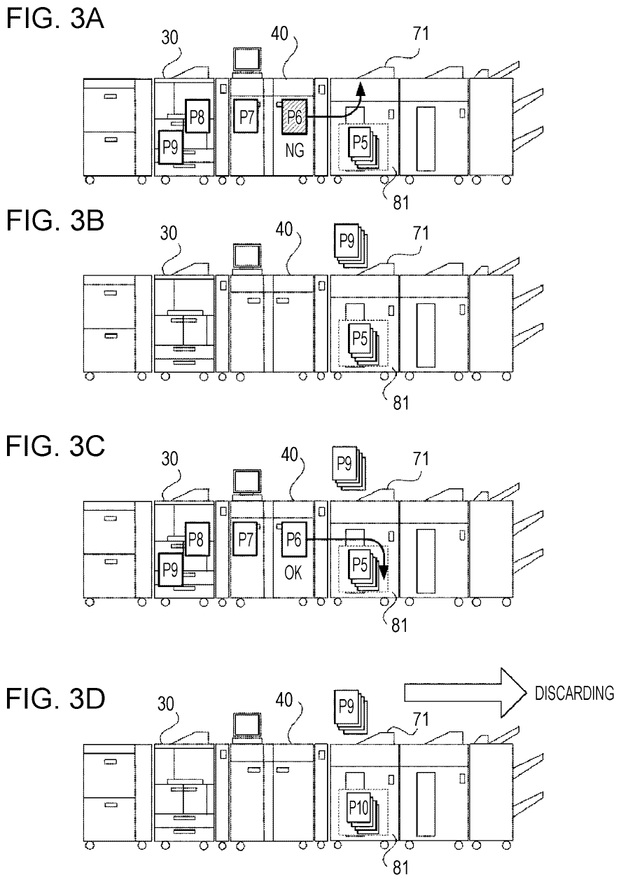

FIGS. 3A through 3D illustrate the process of the image forming system 10 that discharges the purge pages in this way into the top tray 71.

FIG. 3A illustrates the state in which the inspection apparatus 40 has detected a fault in a print result of page 6 with a print result of pages 1 through 5 held in the stacker tray 81. When the fault is detected, subsequent pages 7 through 9 have been printed. The discharge destination is thus changed such that the print result including pages 6 through 9 is discharged as purge pages into the top tray 71.

Through this operation, as illustrated in FIG. 3B, pages 1 through 5 as a normal print result is held in the stacker tray 81 while pages 6 through 9 including page 6 determined to have the faulty print result detected are discharged into the top tray 71. The printer 30 then suspends the printing operation.

The printer 30 resumes printing starting with page 6 as illustrated in FIG. 3C. The inspection apparatus 40 may now determine in the inspection that page 6 is normal after reprinting. For this reason, page 6 and subsequent pages are discharged into the stacker tray 81.

Referring to FIG. 3D, as a result, when the printer 30 has completed the printing operation, the normal pages 1 through 10 are held in the stacker tray 81 while pages 6 through 9 including page 6 having the faulty print result are discharged into the top tray 71. The print result including pages 6 through 9 discharged into the top tray 71 are to be discarded.

A printed material having a print content higher in confidentiality, such as a printed material including personal information, is typically discharged into the discharge destination that causes the print content to be difficult to visually recognize, such as the stacker tray 81. If a purge page in a printed material higher in confidentiality is discharged into the discharge destination that is visually recognizable from the outside, such as the top tray 71, the content of the printed material may be possibly leaked.

Particularly when a large number of pages possibly taking a longer time before the completion of the printing operation are printed, disposal pages, such as purge pages, go unattended in the top tray 71 until the completion of the printing operation.

By performing the control operation described below, the image forming system 10 in the exemplary embodiment may block the leaks of the print content of the disposal pages of the printed material having the print content higher in confidentiality.

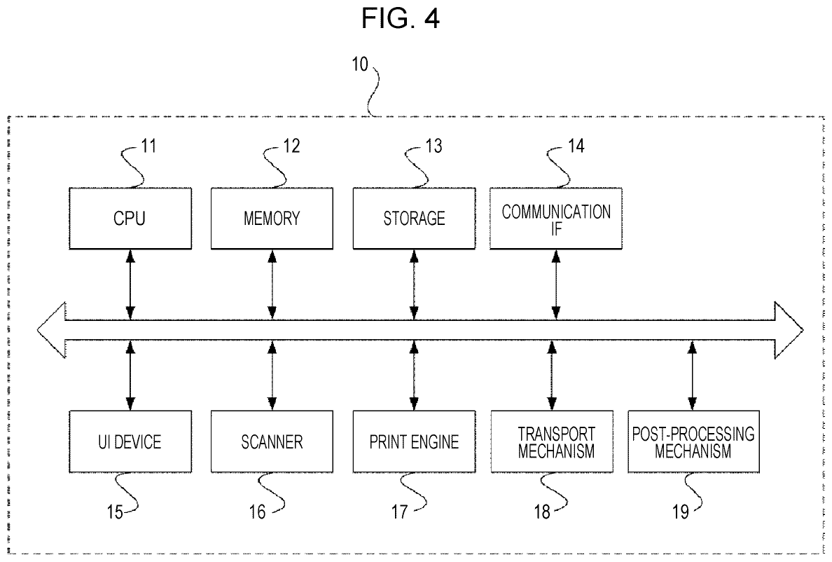

FIG. 4 illustrates the hardware configuration of the image forming system 10 in the exemplary embodiment. Referring to FIG. 4, for convenience of explanation, the image forming system 10 has a hardware configuration having one central processing unit (CPU) but the image forming system 10 may have a hardware configuration in which the printer 30, inspection apparatus 40, large-capacity stacker apparatuses 51 and 52 and post-processing apparatus 60 are respectively equipped with their own CPUs.

As illustrated in FIG. 4, the image forming system 10 includes a CPU 11, memory 12, storage 13 such as a hard disk drive, communication interface (IF) 14 transmitting data to or receiving data from an external apparatus via a network, user interface (UI) device 15 including a touch panel or a liquid-crystal display and keyboard, scanner 16, print engine 17, transport mechanism 18 and post-processing mechanism 19. Those elements are interconnected to each other via a control bus.

The print engine 17 prints an image on a recording medium, such as a paper sheet, through charging, exposure, development, fixing and other operations. The recording medium may include paper, film or the like or may be anything that allows an image to be printed thereon.

The CPU 11 performs a specific operation in accordance with a control program stored on the memory 12 or the storage 13 and is a processor controlling the process of the image forming system 10. According to the exemplar embodiment, the CPU 11 retrieves the control program from the memory 12 or the storage 13 and executes the retrieved control program but the disclosure is not limited to this method. The control program may be delivered in a recorded form on a computer-readable medium. For example, the control program may be delivered in a recorded form on an optical disc, such a compact disc read-only memory (CD-ROM) or digital versatile disc ROM (DVD-ROM), or semiconductor memory such as a universal serial bus (USB) memory or memory card. The control program may be retrieved from an external apparatus via a communication network connected to the communication IF 14. The control program may be supplied as standalone application software or may be supplied by building the control program into software of an element having a function of the image forming system 10.

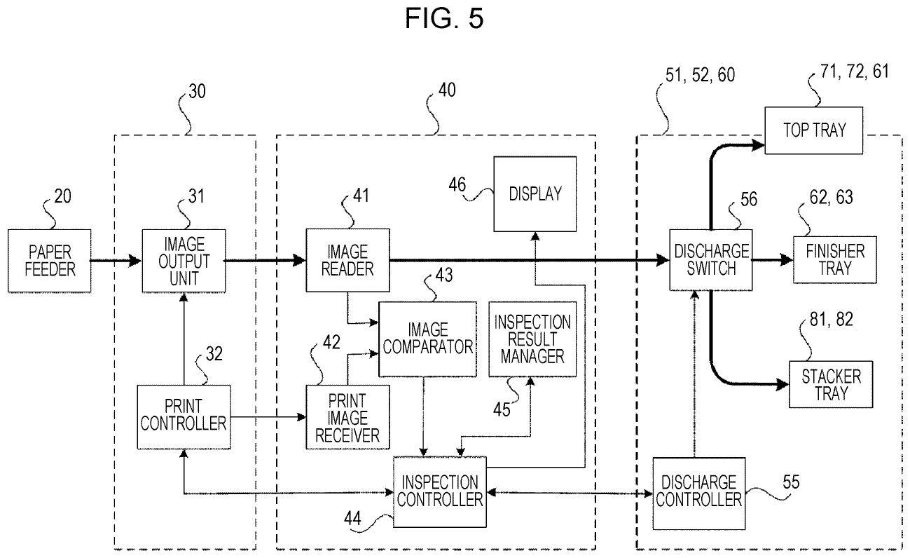

FIG. 5 is a block diagram illustrating the functional configuration of the image forming system 10 implemented when the control program is executed.

As illustrated in FIG. 5, in the image forming system 10 in the exemplary embodiment, the printer 30 includes an image output unit 31 and print controller 32. The inspection apparatus 40 includes an image reader 41, print image receiver 42, image comparator 43, inspection controller 44, inspection result manager 45 and display 46. Each of the large-capacity stacker apparatuses 51 and 52 and post-processing apparatus 60 includes top trays 71, 72 and 61, finisher trays 62 and 63, stacker trays 81 and 82, discharge switch 56 and discharge controller 55. Note that the post-processing mechanism 19 is not illustrated in the post-processing apparatus 60 in FIG. 5.

The paper feeder 20 holds the paper sheets before an image is formed thereon and then feeds the paper sheets to the image output unit 31. The image output unit 31 prints an image on the paper sheets fed by the paper feeder 20. The print controller 32 controls the process of the image output unit 31, causing the image output unit 31 to perform an operation to print the image on the paper sheet. Note that the print controller 32 transmits information on a print image printed on the paper sheet to the inspection controller 44 in the inspection apparatus 40.

The image reader 41 in the inspection apparatus 40 reads the image from the paper sheet having the image printed by the image output unit 31. The print image receiver 42 receives as a reference image the print image transmitted from the print controller 32.

The image comparator 43 compares a scan image read by the image reader 41 with the reference image as the print image received by the print image receiver 42 in order to determine whether the image printed on the paper sheet has any fault, such as a print fault. Specifically, by comparing the scan image with the reference image, the image comparator 43 detects printing stains, printing blur, toner fault or the like on the printed paper sheet. Note that the image comparator 43 may set one of the images read by the image reader 41 to be a reference image and compare the reference image with the other scan images.

The inspection controller 44 controlling the process of the inspection apparatus 40 receives inspection results from the image comparator 43 and inspects the printed image by determining whether a detected fault is in excess of a preset threshold of the inspection. The inspection result manager 45 stores and manages the inspection results of the inspection controller 44.

The inspection controller 44 transmits the inspection results to the print controller 32 and discharge controller 55. Specifically, the inspection controller 44 transmits to the print controller 32 information on the page that has been determined to have a print fault and information on the page that reprinting is to be started with. The inspection controller 44 also transmits to the discharge controller 55 information on the page that has been determined to have the print fault and information on the purge page serving as information on a page that is to be discarded before reprinting is performed. The inspection controller 44 also displays information on the inspection results and the like on the display 46.

The discharge switch 56 switches the discharge destination of the paper sheet transported from the inspection apparatus 40 to one of the top trays 71, 72 and 61, finisher trays 62 and 63 and stacker trays 81 and 82. In accordance with the information on the purge page and the like transmitted from the inspection controller 44, the discharge controller 55 performs control to provide the discharge switch 56 with an instruction about which discharge destination the discharge switch 56 is to switch to.

The print controller 32, inspection controller 44 and discharge controller 55 operate in concert with each other by transmitting or receiving information to or from each other, thereby controlling the overall process of the image forming system 10.

The image forming system 10 in the exemplary embodiment is configured as described above and is thus enabled to switch the discharge destination to a different tray such that the paper sheets that the inspection apparatus 40 has determined to be normal are discharged into one tray and the paper sheets of the purge pages including a paper sheet that the inspection apparatus 40 has determined to have a print fault are discharged into another tray. The functions of the print controller 32, the inspection controller 44 and the discharge controller 55 may be implemented by a terminal apparatus external to the image forming system 10 and the terminal apparatus may control the process of the image forming system 10 from the outside.

As described above, the inspection apparatus 40 inspects each page of a printed material for the presence or absence of a fault. According to the exemplar embodiment, by controlling the discharge controller 55, the inspection controller 44 determines to be disposal pages purge pages including a page determined to have a fault and discharges the disposal pages into a discharge destination different from a discharge destination into which a page determined to be free from any fault is discharged. When the disposal pages are discharged into the discharge destination different from the discharge destination into which the page determined to be free from any fault is discharged, the inspection controller 44 performs switching to discharge the disposal pages of the printed material having a print content set to be higher in confidentiality into a discharge destination that causes the print content of the printed material to be difficult to visually recognize or causes the print content to be visually unrecognizable from the outside rather than into a discharge destination into which the disposal pages of the printed material not set to be higher in confidentiality are discharged.

The inspection controller 44 controls the discharge controller 55 such that with respect to the printed material having the print content set to be not higher in confidentiality, the page determined to be free from any fault is discharged into the stacker tray 81 while the disposal pages are discharged into the top tray 71. With respect to the printed material having the print content set to be higher in confidentiality, the inspection controller 44 controls the discharge controller 55 such that the page determined to be free from any fault is discharged into the stacker tray 81 while the disposal pages are discharged into the stacker tray 82.

The disposal pages include the page that the inspection apparatus 40 has determined to have a fault and the other pages that are subsequent to that page and in the middle of transportation along a paper transport path.

The stacker tray 82 is configured to cause the discharged paper sheet to be protected by a door and, in view of the top tray 71, causes the print content of the printed material to be difficult to visually recognize or causes the print content to be visually unrecognizable from the outside.

The stacker trays 81 and 82 may be configured to have a lockable door such that a printed material held inside is difficult to take out as long as the door is locked and closed. Such a configuration may restrict the occurrence that a third party passing by takes away the disposal pages.

The door of the stacker trays 81 and 82 may be equipped with a window used to visually recognize an amount of printed material held inside from the outside. Reading the content of the printed material held in the stacker trays 81 and 82 through the window may be considered difficult. The possibility of leaks of the content of the printed material is lowered more when the disposal pages are held in the stacker tray 82 than when the disposal pages are left in the top trays 71 and 72 or the like for a long time.

After the disposal pages are discharged into the stacker tray 82, the inspection controller 44 controls the print controller 32 such that reprinting is executed starting with the page determined to have a fault.

When the stacker tray 82 used to receive the disposal pages has already another printed material held, the inspection controller 44 may discharge the disposal pages into the top tray 71 and then suspend the printing operation of the printed material without performing the reprinting starting with the page determined to have a fault. With the printing operation of the printed material suspended, the user may be more likely to recognize that the disposal pages are discharged into the top tray 71.

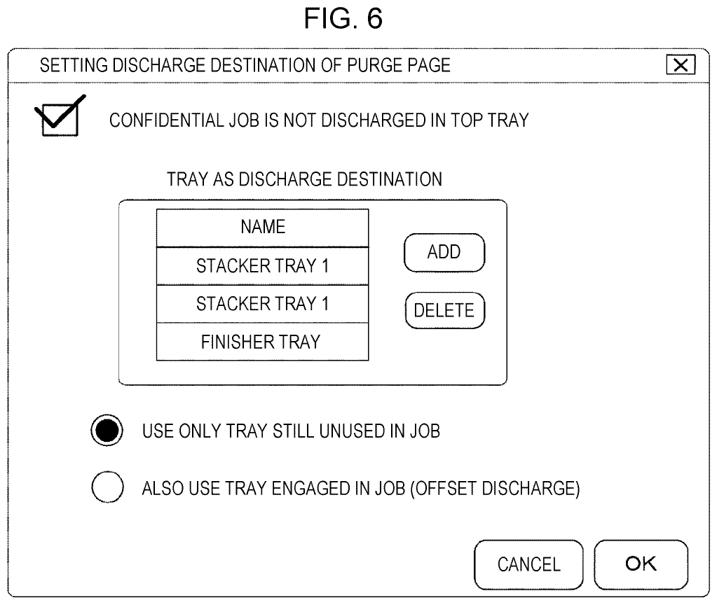

FIG. 6 illustrates a setting screen used when the function described above is set to be enabled or disabled.

Referring to the setting screen illustrated in FIG. 6, a check box for the sentence reading “Confidential job is not discharged into top tray” is checked and the setting to enable the function described above is thus selected. The function is disabled when the user removes a check mark, and the disposal pages of the printed material set to be higher in confidentiality are also discharged into the top tray 71.

Referring to the setting screen in FIG. 6, the discharge destination of the disposal pages may thus be designated. In the setting screen in FIG. 6, one of “stacker tray 1,” “stacker tray 2,” and “finisher tray” may be selectable as a discharge destination of the disposal pages. Note that a discharge destination of the disposal pages may be deleted from the setting screen or added to the setting screen in FIG. 6.

The setting screen in FIG. 6 allows one of operation items “Use only tray still unused in job” and “Also use tray engaged in job (offset discharge)” to be selectable.

When the operation item “Use only tray still unused in job” is selected with the stacker tray 82 designated as a discharge destination for another print job, the inspection controller 44 does not select the stacker tray 82 as a discharge destination of the disposal pages. The reason why the stacker tray 82 is not selected is that if the disposal pages and the printed material of another print job are to be discharged into the same discharge destination, the disposal pages may mix into another printed material and the print content of the disposal pages may be leaked.

Even when the stacker tray 82 used to receive the disposal pages is designated as a discharge destination of another printed material, the inspection controller 44 may still discharge the disposal pages into the stacker tray 82. In such a case, the inspection controller 44 controls the discharge controller 55 such that the disposal pages are discharged at a position shifted from a standard discharge position, namely, at an offset position.

When an instruction to start printing of another printed material is provided with a discharge destination being the stacker tray 82 into which the disposal pages of the printed material set to be higher in confidence have been discharged, the print controller 32 may prompt the user to start printing of the printed material after discarding the disposal pages discharged into the stacker tray 82.

The inspection controller 44 sets, to be a printed material having a print content higher in confidence, a printed material for which the user has input an indication indicative of higher confidence or a printed material that is determined to be higher in confidence in accordance with a print content. Specifically, the inspection controller 44 sets, to be a target of the above-described control as a printed material higher in confidentiality, the printed material for which the user has input via a screen operation the indication indicative of higher confidence. The inspection controller 44 may also determine to be a printing material higher in confidence the printed material that results from printing personal information different from page to page and the inspection controller 44 may thus set the printing material higher in confidence to be the target of the above-described control.

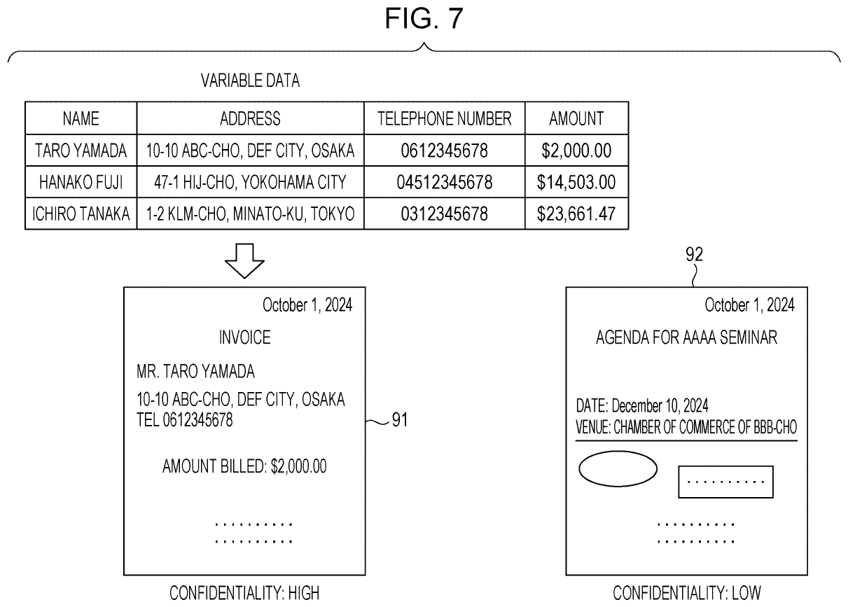

FIG. 7 illustrates an example of a determination method used when confidentiality is determined in accordance with the print content.

Printed material 91 includes print contents that are different from page to page and each page is generated using variable data including the personal information, such as name, address, telephone number and amount billed and the inspection controller 44 determines to be higher in confidentiality the printed material 91 that is different in content from page to page. Conversely, the inspection controller 44 determines to be lower in confidentiality a printed material 92 with the pages having the same contents. Alternatively, the print controller 32 may perform the determination as to whether a printed material is higher or lower and then transmit the determination results to the inspection controller 44.

The control process of the image forming system 10 of the exemplary embodiment is described in detail with reference to the drawings.

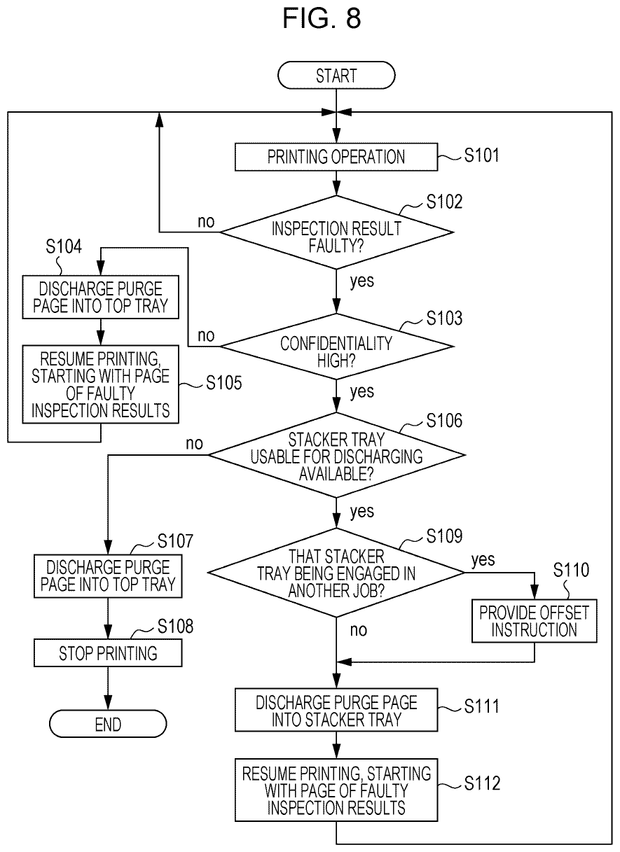

FIG. 8 is a flowchart illustrating the control process of the image forming system 10 of switching the discharge destination in the exemplary embodiment.

The printer 30 performs a printing operation on each page in step S101. In response, the inspection apparatus 40 performs inspection as to whether the print result indicates a fault on each page in step S102.

If the inspection apparatus 40 determines in step S102 that the print result is free from any fault, the printer 30 continues the printing operation. If the inspection indicates a fault in the print result in step S102, a determination is made in step S103 as to whether the printed material is set to be higher in confidentiality.

If the determination determines in step S103 that the printed material is not set to be higher in confidentiality, the inspection controller 44 controls the discharge controller 55 in step S104 such that the disposal pages are discharged into the top tray 71. The inspection controller 44 instructs in step S105 the print controller 32 to resume printing starting with a page determined to have a fault in the inspection. The printer 30 then returns to step S101 to continue the printing operation.

If the determination determines in step S103 that the printed material is set to be higher in confidentiality, the inspection controller 44 determines in step S106 whether any stacker tray available to receive the disposal pages is present.

If the inspection controller 44 determines in step S106 that any stacker tray available to receive the disposal pages is not present, the inspection controller 44 controls the discharge controller 55 in step S107 such that the disposal pages are discharged into the top tray 71. In step S108, the inspection controller 44 stops the printing operation by controlling the print controller 32.

If the inspection controller 44 determines in step S106 that a stacker tray available to receive the disposal pages is present, the inspection controller 44 determines in step S109 whether that stacker tray is currently being used for another print job. The stacker tray 82 may now be found as a stacker tray available to receive the disposal pages.

If the inspection controller 44 determines in step S109 that the stacker tray 82 is currently being used for another print job, the inspection controller 44 controls the discharge controller 55 in step S110 such that the disposal pages are offset and discharged into the stacker tray 82.

If the inspection controller 44 determines in step S109 that the stacker tray 82 is not currently being used for another print job, the inspection controller 44 controls the discharge controller 55 in step S111 such that the disposal pages are discharged into the stacker tray 82.

In step S112, the inspection controller 44 instructs the print controller 32 to resume printing starting with a page determined to have a fault in the inspection. The printer 30 then returns to step S101 to continue the printing operation.

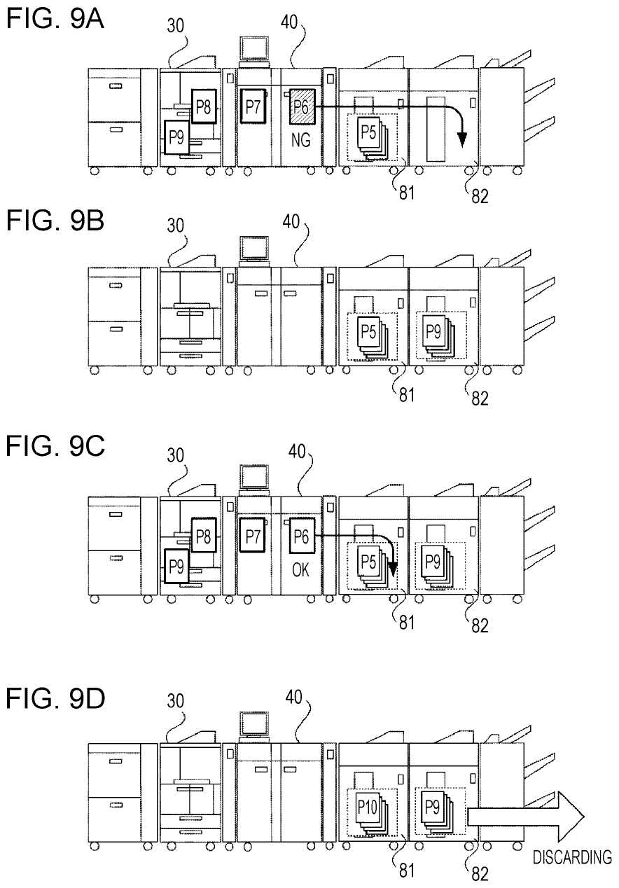

FIGS. 9A through 9D illustrate the process of the image forming system 10 when the disposal pages are discharged as the purge pages into the stacker tray 82.

FIG. 9A illustrates the state in which the inspection apparatus 40 has detected a fault in a print result on page 6 with pages 1 through 5 held in the stacker tray 81. When the fault is detected, subsequent pages 7 through 9 have been printed. The discharge destination is thus changed such that the print result including pages 6 through 9 is discharged as the disposal pages into the stacker tray 82.

Through this operation, as illustrated in FIG. 9B, pages 1 through 5 as a normal print result are held in the stacker tray 81 while pages 6 through 9 including page 6 determined to have a faulty print result detected are discharged into the stacker tray 82. The printer 30 then temporarily suspends the printing operation.

The printer 30 resumes printing starting with page 6 as illustrated in FIG. 9C. The inspection apparatus 40 may now determine in the inspection that page 6 is normal after reprinting. For this reason, page 6 and subsequent pages are discharged into the stacker tray 81.

Referring to FIG. 9D, as a result, when the printer 30 has completed the printing operation, the normal pages 1 through 10 are held in the stacker tray 81 while pages 6 through 9 including page 6 having the faulty print result are discharged into the stacker tray 82. The print result including pages 6 through 9 discharged into the stacker tray 82 are then to be discarded.

In the image forming system 10 of the exemplary embodiment, the disposal page of the printed material set to be higher in confidentiality is discharged not into the top tray 71 but into the stacker tray 82 with the print content difficult to visually recognize from the outside.

The “system” in the exemplary embodiment may be configured to include a single apparatus or multiple apparatuses.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The disclosure may be applicable to a program or a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system including:
a processor configured to:
   inspect a presence or absence of a fault on a printed material; and
   when disposal pages including a page determined to have a fault are to be discharged into a second discharge destination different from a first discharge destination into which a page determined to have no fault is to be discharged, switchably discharge into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.
      (((2)))

In the image forming system according to (((1))), the third discharge destination is a stacker tray that is configured to protect a discharged paper sheet with a door.

(((3)))

In the image forming system according to (((2))), the processor is configured to discharge the disposal page at a position that is shifted from a standard position when the stacker tray used to receive the disposal page is designated to be a discharge destination of a second printed material.

(((4)))

In the image forming system according to (((1))), the processor is configured to, when an instruction to start printing a second printed material to be discharged into the third discharge destination having received the disposal page of the printed material set to be higher in confidentiality is provided, give a user a notification to prompt the user to start printing the second printed material after the disposal page discharged into the third discharge destination is discarded, without executing the instruction to start printing.

(((5)))

In the image forming system according to one of (((1))) through (((4))), the processor is configured to, after the disposal page is discharged into the third discharge destination, perform reprinting starting with a page determined to have a fault.

(((6)))

In the image forming system according to (((5))), the processor is configured to, when the third discharge destination used to receive the disposal page has received a second printed material, discharge the disposal page into the second discharge destination and suspend a printing operation of the printed material without reprinting starting with the page determined to have the fault.

(((7)))

In the image forming system according to one of (((1))) through (((6))), the disposal pages include the page determined to have the fault and a second page that is in middle of transportation on a paper sheet transport path and is subsequent to the page determined to have the fault.

(((8)))

In the image forming system according to one of (((1))) through (((7))), the processor is configured to set to be the printed material having the print content higher in confidentiality a printed material having an indication, indicating a higher confidentiality and input by a user, or a printed material determined to be higher in confidentiality in accordance with a print content.

(((9)))

In the image forming system according to (((8))), the processor is configured to determine to be the printed material higher in confidentiality a printed material on which personal information different from page to page is to be printed.

(((10)))

A program causing a computer to execute a process including:
inspecting a presence or absence of a fault on a printed material; and
when disposal pages including a page determined to have a fault are to be discharged into a second discharge destination different from a first discharge destination into which a page determined to have no fault is to be discharged, switchably discharging into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.

What is claimed is:

1. An image forming system comprising:
a processor configured to:
inspect a presence or absence of a fault on a printed material; and
when disposal pages including a page determined to have a fault are to be discharged into a second discharge destination different from a first discharge destination into which a page determined to have no fault is to be discharged, switchably discharge into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.

2. The image forming system according to claim 1, wherein the third discharge destination is a stacker tray that is configured to protect a discharged paper sheet with a door.

3. The image forming system according to claim 2, wherein the processor is configured to discharge the disposal page at a position that is shifted from a standard position when the stacker tray used to receive the disposal page is designated to be a discharge destination of a second printed material.

4. The image forming system according to claim 1, wherein the processor is configured to, when an instruction to start printing a second printed material to be discharged into the third discharge destination having received the disposal page of the printed material set to be higher in confidentiality is provided, give a user a notification to prompt the user to start printing the second printed material after the disposal page discharged into the third discharge destination is discarded, without executing the instruction to start printing.

5. The image forming system according to claim 1, wherein the processor is configured to, after the disposal page is discharged into the third discharge destination, perform reprinting starting with a page determined to have a fault.

6. The image forming system according to claim 5, wherein the processor is configured to, when the third discharge destination used to receive the disposal page has received a second printed material, discharge the disposal page into the second discharge destination and suspend a printing operation of the printed material without reprinting starting with the page determined to have the fault.

7. The image forming system according to claim 1, wherein the disposal pages include the page determined to have the fault and a second page that is in middle of transportation on a paper sheet transport path and is subsequent to the page determined to have the fault.

8. The image forming system according to claim 1, wherein the processor is configured to set to be the printed material having the print content higher in confidentiality a printed material having an indication, indicating a higher confidentiality and input by a user, or a printed material determined to be higher in confidentiality in accordance with a print content.

9. The image forming system according to claim 8, wherein the processor is configured to determine to be the printed material higher in confidentiality a printed material on which personal information different from page to page is to be printed.

10. A non-transitory computer readable medium storing a program causing a computer to execute a process comprising:
inspecting a presence or absence of a fault on a printed material; and
when disposal pages including a page determined to have a fault are to be discharged into a second discharge destination different from a first discharge destination into which a page determined to have no fault is to be discharged, switchably discharging into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.

11. An image forming method comprising:
inspecting a presence or absence of a fault on a printed material; and
when disposal pages including a page determined to have a fault are to be discharged into a second discharge destination different from a first discharge destination into which a page determined to have no fault is to be discharged, switchably discharging into a third discharge destination rather than into the second discharge destination a disposal page on a printed material having a print content set to be higher in confidentiality, the second discharge destination used to receive a disposal page on a printed material not set to be higher in confidentiality and the third discharge destination causing a print content of a printed material to be difficult to visually recognize or causing the print content to be visually unrecognizable from outside.
